(19) United States
(12) Patent Application Publication
(10) Pub. No.: US 2026/0246019 A1
(43) Pub. Date: Aug. 20, 2026

(54) COOLANT TANK FOR A BATTERY MODULE, BATTERY MODULE, BATTERY PACK, AND VEHICLE

(71) Applicant: Scania CV AB, Södertälje (SE)

(72) Inventors: Johannes STOLTH, Farsta (SE); Linus ÄHRLIG, Västerhaninge (SE); Michael VALLINDER, Mölnbo (SE); Torbjörn ELIASSEN, Järna (SE); Petter JOHNSON, Södertälje (SE); Carl GÖRANSON, Sollentuna (SE); Ola HALL, Stockholm (SE)

(73) Assignee: Scania CV AB, Södertälje (SE)

(21) Appl. No.: 19/161,988

(22) PCT Filed: Mar. 7, 2024
(86) PCT No.: PCT/SE2024/050214

§ 371 Date: Sep. 3, 2025

(30) Foreign Application Priority Data
Mar. 10, 2023 (SE) 2350267-7

(51) Int. Cl. H01M 10/6568; B60L 50/64; B60L 58/26; H01M 10/613; H01M 10/625; H01M 10/643; H01M 10/647; H01M 50/209; H01M 50/213; H01M 50/249; H01M 50/278

(52) U.S. Cl. CPC H01M 10/6568; B60L 50/64; B60L 58/26; H01M 10/613; H01M 10/625; H01M 10/643; H01M 10/647; H01M 50/209; H01M 50/213; H01M 50/249; H01M 50/278; H01M 2220/20

(57) ABSTRACT

A coolant tank for a battery module is disclosed, wherein the coolant tank is configured to accommodate coolant in an inner volume delimited by a number of wall segments of the coolant tank, wherein one wall segment of the number of wall segments forms a number of recessed formations each comprising an outer surface delimiting the inner volume of the coolant tank and an inner surface delimiting a cell compartment for accommodating a battery cell. The present disclosure further relates to a battery module, a battery pack, and a vehicle.

### CROSS-REFERENCE TO RELATED APPLICATIONS

This application is a national stage application (filed under 35 § U.S.C. 371) of PCT/SE2024/050214, filed Mar. 7, 2024, of the same title, which, in turn claims priority to Swedish Patent Application No. 2350267-7, filed on Mar. 10, 2023; the contents of each of which are hereby incorporated by reference.

### TECHNICAL FIELD

The present disclosure relates to a coolant tank for a battery module. The present disclosure further relates to a battery module comprising a coolant tank, a battery pack comprising a number of battery modules, as well as a vehicle comprising a number of battery packs.

### BACKGROUND

The use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

The electricity is usually stored in a number of battery packs comprising a number of rechargeable battery cells. Some different types of battery cells are used, such as lithium-ion battery cells, lithium polymer battery cells, as well as other types of rechargeable battery cells. A large number of battery cells is normally needed to ensure a sufficient available operational range of a vehicle, system voltage and power, especially in battery packs for heavier types of vehicles. A common packing solution is to arranged battery cells in modules each comprising a row of battery cells and arranging several modules side by side in several layers of modules inside a casing to thereby form a battery pack comprising several layers of battery cells inside the casing.

A problem associated with propulsion batteries is that most types of battery cells, such as those listed above, are temperature sensitive meaning that they have a temperature range in which they are most efficient. Moreover, too high temperatures and too low temperatures may damage and/or reduce the lifetime of the propulsion battery. In addition, too high temperatures and too low temperatures may reduce the energy storing capacity of the battery cells of the battery which can have a negative impact on the available operational range of the vehicle.

A battery cell generates heat internally upon charging and discharging and a lot of heat can be generated inside a battery pack during high discharge rates from the battery cells, such as during high output levels of an electric propulsion system of a vehicle. Moreover, vehicles can operate in various temperature conditions which affects the temperature of the battery cells. For the above given reasons, the temperature of a propulsion battery is preferably regulated by a thermal management system of the vehicle.

Traditionally, a battery module for an electric vehicle had battery cells arranged in rows and had a straight coolant pipe placed against each row of battery cells. Known in the art is also a thermal management system using a cooling plate with the battery cells attached thereto, for example using a thermal paste, or the like. These types of solutions provide a limited thermal contact between the battery cells and the coolant pipe/cooling plate which results in a relative low temperature regulating performance of the battery cells. Moreover, because of the limited thermal contact between the battery cells and the coolant pipe/cooling plate, the battery cells may be subjected to a relative uneven cooling which can result in uneven temperatures of the battery cells.

In some operational conditions, such as during startup of a vehicle in low ambient temperatures, heating of the battery cells can be needed to enhance to operational performance of the battery cells. In the above-mentioned types of thermal management systems, the limited heat transferring capacity between the battery cells and the coolant pipe/cooling plate may provide insufficient and/or uneven heating of the battery cells.

Some other types of thermal management systems use immersion cooling in which the battery cells are immersed into a coolant accommodated in a coolant tank. In such solutions, the battery cells are in direct physical contact with the coolant. Immersion cooling provides several advantages. For example, immersion cooling provides a high degree of thermal contact between the battery cells and the coolant which can provide a high temperature regulating performance of the battery cells. Moreover, immersion cooling can provide more even cooling/heating of the battery cells.

However, immersion cooling is also associated with some problems and drawbacks. For example, due to the physical contact between the battery cells and the coolant, a dielectric coolant, i.e., an electrically non-conductive coolant, is normally needed to be used. A dielectric coolant is often more expensive than other types of coolants, such as mixtures of water and glycol. Moreover, apart from the cost-aspect, the use of a dielectric coolant may make service and repair procedures of a battery pack more difficult because dielectric coolant may be more difficult to find and purchase than for example water and glycol. Furthermore, a dielectric coolant can have a lower heat capacity than other types of coolants, such as mixtures of water and glycol. Moreover, it can further be difficult to maintain a good dielectric property over time, which may require frequent coolant changes. In addition, due to the physical contact between the coolant and the battery cells, battery packs using immersion cooling may be more demanding and costly to manufacture due to the number of seals needed.

Furthermore, generally, it is an advantage if products, such as battery packs and associated components, systems, and arrangements, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a coolant tank for a battery module, wherein the coolant tank is configured to accommodate coolant in an inner volume delimited by a number of wall segments of the coolant tank, and wherein one wall segment of the number of wall segments forms a number of recessed formations each comprising an outer surface delimiting the inner volume of the coolant tank and an inner surface delimiting a cell compartment for accommodating a battery cell.

Since the wall segment forms the number of recessed formations each comprising an outer surface delimiting the inner volume of the coolant tank and an inner surface delimiting a cell compartment for accommodating a battery cell, a coolant tank is provided having conditions for providing a high thermal conductivity between battery cells arranged in the cell compartments of the coolant tank and coolant accommodated in the inner volume of the coolant tank without requiring any physical contact between the battery cells and the coolant. Accordingly, due to the features of the coolant tank, conditions are provided for a battery pack in which a high thermal conductivity can be provided between the battery cells and the coolant without requiring any physical contact between the coolant and the battery cells. In other words, due to the features of the coolant tank, the high thermal conductivity provided by immersion cooling can at least in part be replicated without requiring a physical contact between the coolant and the battery cells.

Furthermore, since the high thermal conductivity provided by immersion cooling at least in part can be replicated, conditions are provided for an efficient and uniform regulation of the temperature of battery cells arranged in the cell compartments of the coolant tank. Thereby, conditions are provided for an efficient cooling of the battery cells also in high load situations of the battery cells.

Moreover, due to the features of the coolant tank, the need for using a dielectric coolant is circumvented. Thereby, conditions are provided for lowering manufacturing costs and maintenance costs of a battery pack comprising the coolant tank.

Furthermore, due to the features of the coolant tank, the need for sealing electrical connections of a battery pack comprising the coolant tank is reduced. Also, for this reason, a coolant tank is provided having conditions for reducing manufacturing and assembling costs of battery packs while ensuring an efficient and even temperature regulating capacity of the battery cells of the battery pack.

Moreover, due to the features of the coolant tank, conditions are provided for a battery pack comprising a structurally simple arrangement for cooling battery cells of the battery pack. Also, for this reason, a coolant tank is provided having conditions for reducing manufacturing and assembling costs of battery packs.

Accordingly, a coolant tank is provided overcoming, or at least alleviating, at least some of the above-mentioned problems and drawbacks. As a result, the above-mentioned object is achieved.

Optionally, the inner volume of coolant tank surrounds more than 35 %, or more than 60%, of the circumference of each cell compartment in a plane perpendicular to a center axis of the cell compartment. Thereby, a high thermal conductivity can be ensured between the coolant accommodated in the coolant tank and battery cells arranged in the cell compartments of the coolant tank without requiring any physical contact between the coolant and the battery cells. In other words, due to these features, conditions are provided for an efficient and uniform regulation of the temperature of battery cells arranged in the cell compartments of the coolant tank.

Optionally, the coolant tank comprises a coolant inlet and a coolant outlet, and wherein the coolant tank is configured such that coolant is directed to flow within gaps between adjacent cell compartments when the coolant is pumped into the coolant inlet and through the inner volume of the coolant tank to the coolant outlet. Thereby, an efficient transfer of heat can be ensured between the coolant and battery cells arranged in the cell compartments of the coolant tank.

Optionally, each inner surface of the respective cell compartment defines a venting groove extending from a bottom portion of the cell compartment to a top portion of the cell compartment. Thereby, it can be ensured that any gas formed inside the battery cells arranged in the cell compartments of the coolant tank can be vented in an efficient manner via the venting grooves from the bottom portion of the cell compartments to the top portion of the cell compartments. Moreover, due to these features, a tight fit can be ensured between the inner surfaces defining the cell compartments and battery cells arranged therein while ensuring that any gas formed inside the battery cells can be vented in an efficient manner via the venting grooves. Accordingly, due to these features, conditions are provided for an efficient and uniform regulation of the temperature of battery cells arranged in the cell compartments of the coolant tank.

Optionally, the wall segment is provided in a polymeric material. Thereby, conditions are provided for a light-weighted and durable coolant tank. Moreover, the need for providing electric insulation between the battery cells and the inner surfaces of the cell compartments is circumvented or is at least reduced. Accordingly, a coolant tank is provided having conditions for reducing assembling and manufacturing costs of battery packs.

Optionally, the wall segment is provided by injection moulding. Thereby, a coolant tank is provided having conditions and characteristics suitable for being manufactured in a cost-efficient manner.

Optionally, according to some embodiments, the wall segment is provided in metal. According to these embodiments, each battery cell accommodated in the cell compartments of the coolant tank may be wrapped in an electrically insulating material.

According to a second aspect of the invention, the object is achieved by a battery module comprising a coolant tank according to some embodiments of the present disclosure and a number of battery cells each arranged in a cell compartment of the coolant tank.

Since the wall segment of the coolant tank forms the number of recessed formations each comprising an outer surface delimiting the inner volume of the coolant tank and an inner surface delimiting a cell compartment for accommodating a battery cell, a coolant tank is provided having conditions for providing a high thermal conductivity between the battery cells arranged in the cell compartments of the coolant tank and coolant accommodated in the inner volume of the coolant tank without requiring any physical contact between the battery cells and the coolant. Accordingly, due to the features of the battery module, a high thermal conductivity can be provided between the battery cells and the coolant without any physical contact between the coolant and the battery cells. In other words, due to the features of the battery module, the high thermal conductivity provided by immersion cooling can at least in part be replicated without requiring a physical contact between the coolant and the battery cells.

Furthermore, since the high thermal conductivity provided by immersion cooling at least in part can be replicated, conditions are provided for an efficient and uniform regulation of the temperature of battery cells arranged in the cell compartments of the coolant tank of the battery module. Thereby, conditions are provided for an efficient cooling of the battery cells also in high load situations of the battery cells of the battery module.

Moreover, due to the features of the battery module, the need for using a dielectric coolant is circumvented. Thereby, conditions are provided for lowering manufacturing costs and maintenance costs of the battery module.

Furthermore, due to the features of the coolant tank of the battery module, the need for sealing electrical connections of the battery module is reduced. Also, for this reason, a battery module is provided having conditions for reduced manufacturing and assembling costs while ensuring an efficient and even temperature regulating capacity of the battery cells of the battery module.

Moreover, a battery module is provided comprising a structurally simple arrangement for cooling the battery cells of the battery module. Also, for this reason, a battery module is provided having conditions and characteristics suitable for being manufactured and assembled in a cost-efficient manner.

Accordingly, a battery module is provided overcoming, or at least alleviating, at least some of the above-mentioned problems and drawbacks. As a result, the above-mentioned object is achieved.

Optionally, each of the number of battery cells has a shape conforming to the shape of the cell compartments of the coolant tank. Thereby, a high thermal conductivity can be ensured between the coolant accommodated in the coolant tank and battery cells arranged in the cell compartments of the coolant tank without requiring any physical contact between the coolant and the battery cells. In addition, a space-efficient arrangement of the battery cells can be provided so as to obtain a power dense battery module.

Optionally, the battery cells and the cell compartments are cylindrical. Thereby, a high thermal conductivity can be ensured between the coolant accommodated in the coolant tank and battery cells arranged in the cell compartments of the coolant tank without requiring any physical contact between the coolant and the battery cells. In addition, a space-efficient arrangement of the battery cells can be provided so as to obtain a power dense battery module.

Optionally, the battery cells and the cell compartments have a respective rectangular cross section in a plane perpendicular to a center axis of the cell compartments. Thereby, a high thermal conductivity can be ensured between the coolant accommodated in the coolant tank and battery cells arranged in the cell compartments of the coolant tank without requiring any physical contact between the coolant and the battery cells. In addition, an even further space-efficient arrangement of the battery cells can be provided so as to obtain a power dense battery module.

Optionally, a depth of each cell compartment is at least 20%, or at least 35% of the length of each battery cell as measured in a direction parallel to a center axis of each cell compartment. Thereby, conditions are provided for an efficient and uniform regulation of the temperature of battery cells arranged in the cell compartments of the coolant tank. Thereby, conditions are provided for an efficient cooling of the battery cells also in high load situations of the battery cells.

Optionally, the battery module comprises a connection plate, and wherein each of the number of battery cells are attached to the connection plate. Thereby, a battery module is provided having conditions and characteristics suitable for being manufactured and assembled in a cost-efficient manner.

Optionally, the connection plate comprises a number of electrical conductors, and wherein each of the number of battery cells is electrically connected to at least one electrical conductor of the connection plate. Thereby, electrical connections to/from the number of battery cells can be provided in an efficient and cost-effective manner.

Optionally, the connection plate comprises a plate body and a number of electrical conductors arranged on the plate body, and wherein the plate body is provided in a polymeric material. Thereby, conditions are provided for a light-weighted and durable battery module. Moreover, the need for providing electric insulation between various parts of the battery module is reduced. Moreover, a battery module is provided having conditions and characteristics suitable for being manufactured and assembled in a cost-efficient manner.

According to a third aspect of the invention, the object is achieved by a battery pack configured to supply electricity to an electric propulsion system of a vehicle, wherein the battery pack comprises a number of battery modules according to some embodiments of the present disclosure.

Since the wall segments of the coolant tanks of the battery pack form a number of recessed formations each comprising an outer surface delimiting the inner volume of the coolant tank and an inner surface delimiting a cell compartment for accommodating a battery cell, a battery pack is provided having conditions for providing a high thermal conductivity between the battery cells and coolant accommodated in the inner volume of the coolant tanks without requiring any physical contact between the battery cells and the coolant. In other words, due to the features of the battery pack, the high thermal conductivity provided by immersion cooling can at least in part be replicated without requiring a physical contact between the coolant and the battery cells.

As a further result, conditions are provided for an efficient and uniform regulation of the temperature of battery cells arranged in the cell compartments of the coolant tanks of the battery pack. Thereby, conditions are provided for an efficient cooling of the battery cells also in high load situations of the battery cells of the battery pack.

Moreover, due to the features of the battery pack, the need for using a dielectric coolant is circumvented. Thereby, conditions are provided for a battery pack having low manufacturing costs and maintenance costs.

Furthermore, due to the features of the coolant tanks of the battery pack, the need for sealing electrical connections of the battery pack is reduced. Also, for this reason, a battery pack is provided having conditions for reduced manufacturing and assembling costs while ensuring an efficient and even temperature regulating capacity of the battery cells of the battery pack.

Moreover, a battery pack is provided comprising a structurally simple arrangement for cooling the battery cells of the battery pack. Also, for this reason, a battery pack is provided having conditions and characteristics suitable for being manufactured and assembled in a cost-efficient manner.

Accordingly, a battery pack is provided overcoming, or at least alleviating, at least some of the above-mentioned problems and drawbacks. As a result, the above-mentioned object is achieved.

According to a fourth aspect of the invention, the object is achieved by a vehicle comprising an electric propulsion system configured to provide motive power to the vehicle and a number of battery packs according to some embodiments of the present disclosure. Thereby, a vehicle is provided having at least some of the above-mentioned advantages. In other words, a vehicle is provided overcoming, or at least alleviating, at least some of the above-mentioned problems and drawbacks. As a result, the above-mentioned object is achieved.

Optionally, the vehicle comprises a battery coolant system configured to circulate coolant through the inner volumes of the coolant tanks of the battery modules of the number of battery packs. Thereby, an efficient and even temperature regulating capacity of the battery cells of the battery pack/packs can be ensured while circumventing the need for a physical contact between coolant and the battery cells of the battery pack/packs.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments of the present disclosure,

FIG. 2 schematically illustrates a battery pack of the vehicle illustrated in FIG. 1,

FIG. 3 schematically illustrates a battery module according to some embodiments,

FIG. 4 schematically illustrates a coolant tank of the battery module illustrated in FIG. 3,

FIG. 5 schematically illustrates a perspective view of a connection plate of the battery module illustrated in FIG. 3,

FIG. 6 schematically illustrates a second perspective view of the coolant tank of the battery module illustrated in FIG. 3 in which the coolant tank is illustrated in a partly assembled state,

FIG. 7 schematically illustrates a first cross section of a portion of the battery module illustrated in FIG. 3,

FIG. 8 schematically illustrates a second cross section of a portion of the battery module illustrated in FIG. 3,

FIG. 9 schematically illustrates a battery module according to some further embodiments,

FIG. 10 schematically illustrates a coolant tank of the battery module illustrated in FIG. 9,

FIG. 11 schematically illustrates a perspective view of a connection plate of the battery module illustrated in FIG. 9,

FIG. 12 schematically illustrates a second perspective view of the coolant tank of the battery module illustrated in FIG. 9 in which the coolant tank is illustrated in a partly assembled state,

FIG. 13 schematically illustrates a first cross section of a portion of the battery module illustrated in FIG. 9, and

FIG. 14 schematically illustrates a second cross section of the battery module illustrated in FIG. 9.

### DETAILED DESCRIPTION

Aspects of the present invention will now be described more fully. Like reference signs refer to like elements throughout. Well-known functions or constructions will not necessarily be described in detail for brevity and/or clarity.

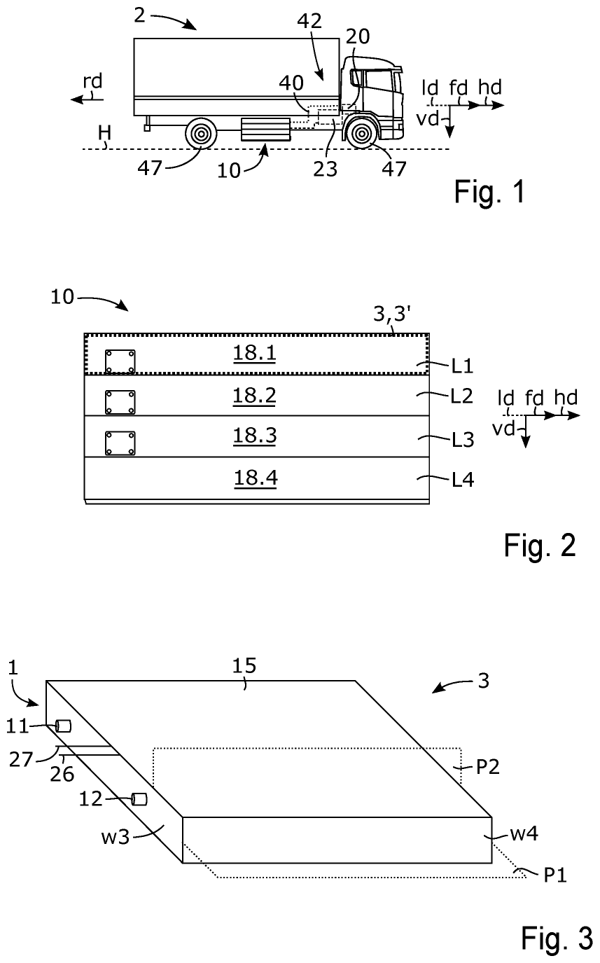

FIG. 1 schematically illustrates a vehicle 2 according to some embodiments of the present disclosure. According to the illustrated embodiments, the vehicle 2 is a truck, i.e., a type of heavy road vehicle, as well as a type of heavy commercial vehicle. According to further embodiments, the vehicle 2, as referred to herein, may be another type of heavy or lighter type of manned or unmanned vehicle for land or water-based propulsion such as a lorry, a bus, a construction vehicle, a tractor, a car, a ship, a boat, or the like.

The vehicle 2 comprises an electric powertrain 42. According to the illustrated embodiments, the electric powertrain 42 is configured to provide motive power to the vehicle 2 via wheels 47 of the vehicle 2. The electric powertrain 42 comprises an electric propulsion system 20. The electric propulsion system 20 is capable of providing motive power to the vehicle 2 via wheels 47 of the vehicle 2 as well as providing regenerative braking of the vehicle 2. Thus, according to the illustrated embodiments, the electric propulsion system 20 comprises an electric machine capable of operating as an electric motor as well as an electric generator. The electric machine of the electric propulsion system 20 of the vehicle 2 may also be referred to as a vehicle propulsion motor/generator.

According to the illustrated embodiments, the electric powertrain 42 of the vehicle 2 is a pure electric powertrain 42, i.e., a powertrain comprising no internal combustion engine.

According to further embodiments, the electric powertrain 42 of the vehicle 2 may be a so-called hybrid electric powertrain 42 comprising a combustion engine in addition to the electric propulsion system 20 for providing motive power to the vehicle 2.

Moreover, as is indicated in FIG. 1, the vehicle 2 comprises a battery pack 10 and an electric system 40. The battery pack 10 is operably connected to the electric propulsion system 20 via the electric system 40. In other words, the battery pack 10 is configured to provide electricity to the electric propulsion system 20 via the electric system 40. Moreover, according to the illustrated embodiments, the battery pack 10 is configured to receive electricity from the electric propulsion system 20 via the electric system 40 during regenerative braking of the vehicle 2. As is further explained herein, the battery pack 10 comprises a number of battery cells. In FIG. 1, the vehicle 2 is illustrated as comprising one battery pack 10. However, the vehicle 2 may comprise more than one battery pack 10.

In FIG. 1, the vehicle 2 is illustrated as positioned onto a flat horizontal surface H in an intended use position. Moreover, in FIG. 1, a vertical direction vd of the vehicle 2 is indicated. The vertical direction vd of the vehicle 2 is perpendicular to the flat horizontal surface H when the vehicle 2 is positioned thereon in the intended use position. Moreover, the vertical direction vd of the vehicle 2 coincides with a local gravity vector at the location of the vehicle 2 when the vehicle 2 positioned onto a flat horizontal surface H in an intended use position. In FIG. 1, a horizontal direction hd of the vehicle 2 is indicated. The horizontal direction hd of the vehicle 2 is parallel to the flat horizontal surface H when the vehicle 2 is positioned thereon in the intended use position.

As can be seen in FIG. 1, the wheels 47 of the vehicle 2 are abutting against the flat horizontal surface Hs when the vehicle 2 is positioned in the intended upright use position on the flat horizontal surface Hs. The vehicle 2 has a longitudinal direction Id. The longitudinal direction Id of the vehicle 2 is parallel to the flat horizontal surface Hs when the vehicle 2 is positioned in the intended upright use position thereon. Moreover, the longitudinal direction Id of the vehicle 2 is parallel to a forward moving direction fd of the vehicle 2 as well as to a reverse moving direction rd of the vehicle 2. The reverse moving direction rd of the vehicle 2 is opposite to the forward moving direction fd of the vehicle 2.

FIG. 2 schematically illustrates the battery pack 10 of the vehicle 2 illustrated in FIG. 1. The battery pack 10 comprises a number of layers L1, L2, L3, L4 of battery cells. The reference sign for the layers L1, L2, L3, L4 of battery cells is abbreviated “L1-L4” in some places herein for reasons of brevity and clarity. According to the embodiments illustrated in FIG. 2, the battery pack 10 comprises four layers L1-L4 of battery cells. However, the battery pack 10 may comprise another number of layers L1-L4 of battery cells, such as a number between one and twelve, or a number between one and eight. According to the illustrated embodiments, each layer L1-L4 of battery cells comprises a number of battery modules 3, 3′, wherein each battery module 3, 3′ comprises a number of battery cells.

In FIG. 2, the longitudinal direction Id, the forward moving direction fd, the horizontal direction hd, and the vertical direction vd of the vehicle 2 illustrated in FIG. 1 are illustrated. The battery pack 10 illustrated in FIG. 2 is illustrated in an intended mounting orientation relative to these directions. Below, simultaneous reference is made to FIG. 1 and FIG. 2, if not indicated otherwise. According to the embodiments illustrated in FIG. 2, the number of layers L1-L4 of battery cells are stacked on top of each other along the vertical direction vd of the vehicle 2. However, according to further embodiments, the number of layers L1-L4 of battery cells may be oriented and stacked in another manner relative to the vertical direction of the vehicle 2.

In FIG. 2, only a battery module 3, 3′ of one layer L1 of battery cells is indicated. However, as understood from the above, each layer L1-L4 of battery cells comprises a number of battery modules 3, 3′. Moreover, in FIG. 2, one layer L1 of battery cells is illustrated as comprising one battery module 3, 3′. However, each layer L1-L4 of battery cells may comprise another number of battery modules 3, 3′.

Moreover, according to the illustrated embodiments, the battery pack 10 comprises a number of casing sections 18.1, 18.2, 18.3, 18.4. The reference sign for the casing sections 18.1, 18.2, 18.3, 18.4 of the casing 7 is abbreviated “18.1-18.4” in some places herein for reasons of brevity and clarity. According to the illustrated embodiments, each casing section 18.1-18.4 is configured to accommodate one layer L1-L4 of battery cells. According to the illustrated embodiments, two adjacent casing sections 18.1-18.4 of the number of casing sections 18.1-18.4 are attached to each other via a number of fastening elements.

FIG. 3 schematically illustrates a battery module 3 according to some embodiments. As indicated in FIG. 2, the battery pack 10 may comprise a number of battery modules 3 according to the embodiments illustrated in FIG. 3.

The battery module 3 comprises a connection plate 15 and a coolant tank 1. Moreover, as is further explained herein, the battery module 3 comprises a number of battery cells attached to the connection plate 15. The connection plate 15 comprises electrical connection conductors 26, 27 being electrically connected to the number of battery cells as is further explained below. The coolant tank 1 comprises a coolant inlet 11 and a coolant outlet 12 as can be seen in FIG. 3.

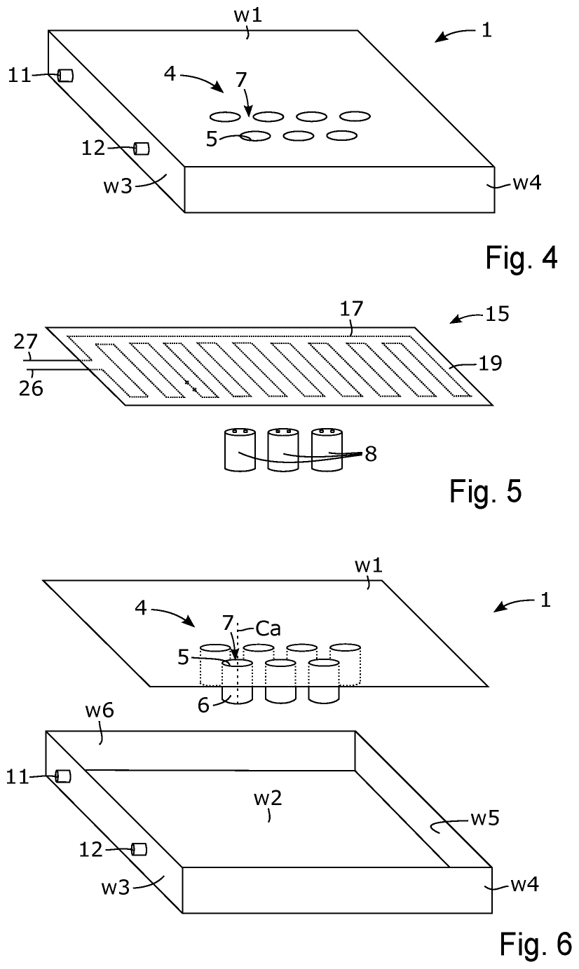

FIG. 4 schematically illustrates the coolant tank 1 of the battery module 3 illustrated in FIG. 3. The coolant tank 1 is configured to accommodate coolant in an inner volume delimited by a number of wall segments w1, w3, w4 of the coolant tank 1. In FIG. 4, three wall segments w1, w3, w4 of the coolant tank 1 are seen and indicated. However, as is further explained below, according to the illustrated embodiments, the coolant tank 1 comprises six wall segments w1, w3, w4.

As can be seen in FIG. 4, one wall segment w1 of the number of wall segments w1, w3, w4 forms a number of recessed formations 4. As is further explained below, each recessed formation 4 of the number of recessed formations 4 comprises an inner surface 5 delimiting a cell compartment 7 for accommodating a battery cell.

For reasons of brevity and clarity, in FIG. 4, the wall segment w1 is schematically illustrated as forming seven recessed formations 4. However, the wall segment w1 may form a significantly larger number of recessed formations 4. Purely as an example, the wall segment w1 may form a number of recessed formations 4 being within the range of 20-200.

FIG. 5 schematically illustrates a perspective view of the connection plate 15 of the battery module 3 illustrated in FIG. 3. Below, simultaneous reference is made to FIG. 1-FIG. 5, if not indicated otherwise.

The connection plate 15 comprises a plate body 19 and a number of electrical conductors 17 arranged on the plate body 19. According to the illustrated embodiments, the plate body 19 is provided in a polymeric material and the number of electrical conductors 17 is provided in metal.

Moreover, FIG. 5 schematically illustrates a number of battery cells 8. Each of the number of battery cells 8 are configured to be attached to the connection plate 15. Moreover, each battery cell 8 of the number of battery cells 8 comprises a pair of electrical poles each being configured to be electrically connected to at least one electrical conductor 17 of the number of electrical conductors 17 arranged on the plate body 19. The electrical poles of the battery cells 8 have not been provided with reference signs in FIG. 5 for reasons of brevity and clarity. The number of electrical conductors 17 is electrically connected to the electrical connection conductors 26, 27 of the connection plate 15.

For reasons of brevity and clarity, only three battery cells 8 are illustrated in FIG. 5. However, the connection plate 15 of the battery module 3 may comprise the same number of battery cells 8 as the number of recessed formations 4 formed by the wall segment w1 of the coolant tank 1 of the battery module 3. In other words, the battery module 3 may comprise a number of battery cells 8 each being arranged in one cell compartment 7 of the coolant tank 1. Each of the number of battery cells 8 may be a lithium-ion battery cell, a lithium polymer battery cell, or the like.

FIG. 6 schematically illustrates a second perspective view of the coolant tank 1 of the battery module 3 illustrated in FIG. 3 in which the coolant tank 1 is illustrated in a partly assembled state in which one wall segment w1 has been removed from the other wall segments w2-w6 of the coolant tank 1. Below, simultaneous reference is made to FIG. 1-FIG. 6, if not indicated otherwise.

In FIG. 6, all wall segments w1-w6 of the coolant tank 1 are seen and are indicated. The wall segments w1-w6 of the coolant tank 1 comprises a bottom wall segment w2 and four side wall segments w3-w6. The bottom wall segment w2 and the four side wall segments w3-w6 may together form one coherent unit. The bottom wall segment w2 and the four side wall segments w3-w6 may be provided in a polymeric material or in metal. The unit formed by the bottom wall segment w2 and the four side wall segments w3-w6 may comprise a fluid-tight seal member arranged against the inner surfaces of the bottom wall segment w2 and the four side wall segments w3-w6, wherein the bottom wall segment w2 and the four side wall segments w3-w6 are arranged to support the fluid-tight seal member.

As mentioned above, one wall segment w1 of the number of wall segments w1-w6 of the coolant tank 1 forms a number of recessed formations 4. Moreover, as mentioned, each recessed formation 4 of the number of recessed formations 4 comprises an inner surface 5 delimiting a cell compartment 7 for accommodating a battery cell 8. Furthermore, as is seen in FIG. 6, each recessed formation 4 of the number of recessed formations 4 comprises an outer surface 6. The outer surfaces 6 of the number of recessed formations 4 delimits the inner volume of the coolant tank 1 when the coolant tank 1 is in an assembled state, as is illustrated in FIG. 4.

According to the illustrated embodiments, the wall segment w1 forming the number of recessed formations 4 constitutes a top wall segment of the coolant tank 1. However, according to further embodiments, the wall segment w1 forming the number of recessed formations 4 may constitute a bottom wall segment or a side wall segment of the coolant tank 1. The feature that the wall segment w1 forming the number of recessed formations 4 constitutes a top wall segment of the coolant tank 1 means that the wall segment w1 is arranged above the bottom wall segment w2 as seen relative to the vertical direction vd of the vehicle 2 when the battery module 3 is arranged in the battery pack 10, the battery pack 10 is mounted to the vehicle 2, and the vehicle 2 is placed in the intended use position onto a flat horizontal surface H.

As is seen in FIG. 6, the number of recessed formations 4 of the wall segment w1 forms a number of recesses as seen from a first side of the wall segment w1 and a number of protrusions as seen from a second side of the wall segment w1, wherein the second side of the wall segment w1 is opposite to the first side of the wall segment w1.

The number of battery cells 8 of the connection plate 15 illustrated in FIG. 5 are configured to be inserted into the cell compartments 7 formed by the number of recessed formations 4 from the first side of the wall segment w1 referred to above. In FIG. 6, a center axis Ca of one of the cell compartments 7 is indicated. The center axis Ca of a cell compartment 7 as referred to herein may be a geometrical center axis in which the distances from the center axis to the inner surfaces 5, which delimits the cell compartment 7, are maximized in all radial directions. The number of battery cells 8 of the connection plate 15 illustrated in FIG. 5 are configured to be inserted into the cell compartments 7 in a direction coinciding with the center axes Ca of the cell compartment 7.

The wall segment w1 forming the number of recessed formations 4 may be provided in a polymeric material. According to such embodiments, the wall segment w1 may be provided by injection moulding. According to some further embodiments, the wall segment w1 forming the number of recessed formations 4 may be provided in metal. According to such embodiments, as well as in other embodiments explained herein, each battery cell 8 of the number of battery cells 8 may be covered by an electric insulator. Moreover, according to such embodiments, the wall segment w1 forming the number of recessed formations 4 may be provided by pressing a metal plate material.

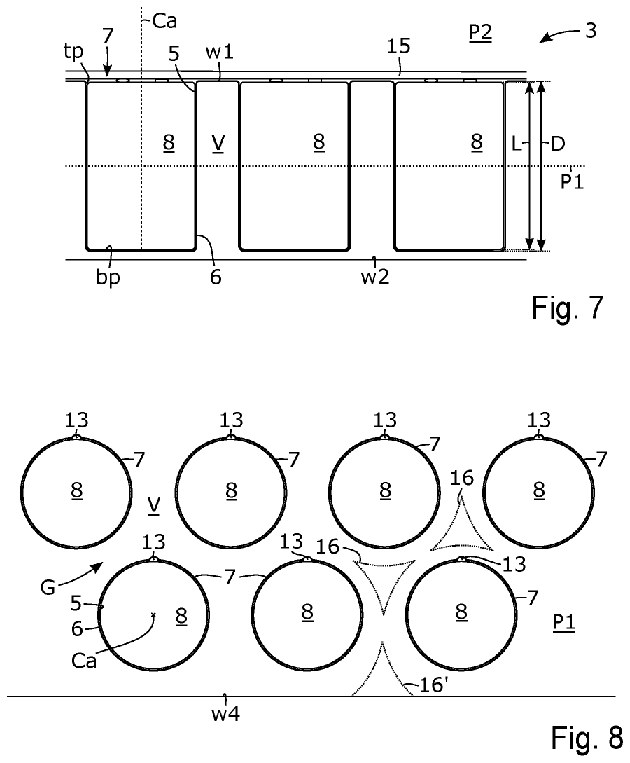

FIG. 7 schematically illustrates a first cross section of a portion of the battery module 3 illustrated in FIG. 3. In FIG. 7, the cross section is made in a plane P2 parallel to the center axes Ca of the cell compartments 7. The plane P2 is also indicated in FIG. 3. Moreover, in FIG. 7, as well as in FIG. 3, a plane P1 being perpendicular to the center axes Ca of the cell compartments 7 is indicated. Below, simultaneous reference is made to FIG. 1-FIG. 7, if not indicated otherwise.

According to the illustrated embodiments, the plane P1 being perpendicular to the center axes Ca of the cell compartments 7 is parallel to the bottom wall segment w2 and to a top surface of the wall segment w1 which forms the recessed formations 4. Moreover, according to the illustrated embodiments, the plane P2 parallel to the center axes Ca of the cell compartments 7 is parallel to two side wall segments w4, w6 of the coolant tank 1.

In FIG. 7, the inner volume V of the coolant tank 1 is indicated. The coolant inlet 11 and the coolant outlet 12 indicated in FIG. 3, FIG. 4, and FIG. 6 are fluidly connected to the inner volume V of the coolant tank 1. Moreover, as is indicated in FIG. 1, the vehicle 2 comprises a battery coolant system 23. The battery coolant system 23 is configured to circulate coolant through the inner volume V of the coolant tank 1 by pumping coolant into the coolant inlet 11 and retrieving coolant from the coolant outlet 12. The coolant may comprise a mixture of water and glycol. This is because the features of the coolant tank 1 of the battery module 3 circumvents the need for using a dielectric coolant while at least in part replicating the advantages of immersion cooling as is further explained herein.

The battery coolant system 23 may comprise one or more radiators configured to radiate heat from coolant retrieved from the coolant outlet 12 of the coolant tank 1 to the surroundings. Moreover, the battery coolant system 23 may comprise a heat pump circuit configured to lower the temperature of coolant supplied to the coolant inlet 11 of the coolant tank 1 to a temperature below ambient temperature. Furthermore, the battery coolant system 23 may comprise a heater, such as an electrical heater, configured to heat coolant before it is supplied to the coolant inlet 11 of the coolant tank 1 for example upon low ambient temperatures.

In FIG. 7, a depth D of a cell compartment 7 is indicated. The depths D of the cell compartments 7 of the coolant tank 1 may be measured in a direction parallel the center axis Ca of each cell compartment 7. Moreover, in FIG. 7, a length L of a battery cell 8 is indicated. Like above, the length L of a battery cell 8 may be measured in a direction parallel to a center axis Ca of each cell compartment 7.

According to the illustrated embodiments, the depth D of each cell compartment 7 is slightly larger than the length L of each battery cell 8 as measured in a direction parallel to a center axis Ca of each cell compartment 7. In other words, according to the illustrated embodiments, the entire length L of each battery cell 8 is accommodated inside each cell compartment 7 of the coolant tank 1. In this manner, an efficient and uniform regulation of the temperature of battery cells 8 can be provided while not requiring any physical contact between the battery cells 8 and the coolant accommodated in the inner volume V of the coolant tank 1. According to further embodiments, the depth D of each cell compartment 7 may be at least 20%, at least 35%, or at least 50% of the length L of each battery cell 8 as measured in a direction parallel to a center axis Ca of each cell compartment 7. In this manner, the advantages of immersion cooling can at least in part be replicated while circumventing the need for a physical contact between the battery cells 8 and the coolant accommodated in the inner volume V of the coolant tank 1.

As is seen in FIG. 7, and as is understood from the above described, the number of battery cells 8 are arranged outside of the inner volume V of the coolant tank 1 when the battery module 3 is in an assembled state.

FIG. 8 schematically illustrates a second cross section of a portion of the battery module 3 illustrated in FIG. 3. In FIG. 8, the cross section is made in a plane P1 perpendicular to the center axes Ca of the cell compartments 7. Below, simultaneous reference is made to FIG. 1-FIG. 8, if not indicated otherwise.

As can be seen when comparing FIG. 4, FIG. 5, FIG. 6, and FIG. 8, according to these embodiments, the battery cells 8 and the cell compartments 7 are cylindrical, i.e., has a circular cross section in a plane P1 perpendicular to the center axes Ca of the cell compartments 7. Moreover, as is best seen in FIG. 7 and FIG. 8, each of the number of battery cells 8 has a shape conforming to the shape of the cell compartments 7 of the coolant tank 1.

Furthermore, as is best seen in FIG. 8, according to the illustrated embodiments, the inner volume V of coolant tank 1 surrounds the entire circumference of each cell compartment 7 in a plane P1 perpendicular to a center axis Ca of the cell compartment 7. In this manner, an efficient and uniform regulation of the temperature of battery cells 8 can be provided while not requiring any physical contact between the battery cells 8 and the coolant accommodated in the inner volume V of the coolant tank 1. According to further embodiments, the inner volume V of coolant tank 1 may surround more than 35 %, or more than 60%, of the circumference of each cell compartment 7 in a plane P1 perpendicular to a center axis Ca of the cell compartment 7. In this manner, the advantages of immersion cooling can at least in part be replicated while circumventing the need for a physical contact between the battery cells 8 and the coolant accommodated in the inner volume V of the coolant tank 1.

Moreover, as is indicated in FIG. 8, according to the illustrated embodiments, the coolant tank 1 is configured such that coolant is directed to flow within gaps G between adjacent cell compartments 7 when the coolant is pumped into the coolant inlet 11 and through the inner volume V of the coolant tank 1 to the coolant outlet 12.

Furthermore, as is indicated in FIG. 8, according to the illustrated embodiments, each inner surface 5 of the respective cell compartment 7 defines a venting groove 13. The venting groove 13 of a cell compartment 7 extends from a bottom portion bp of the cell compartment 7 to a top portion tp of the cell compartment 7. The bottom and top portions bp, tp of a cell compartment 7 are indicated in FIG. 7. Since the venting grooves 13 of the cell compartments 7 extends from the bottom portions bp of the cell compartments 7 to the top portions tp of the cell compartments 7, it can be ensured that any gas formed inside the battery cells 8 can be vented in an efficient manner via the venting grooves 13 from the bottom portion bp of the cell compartments 7 to the top portion tp of the cell compartments 7. Moreover, the venting grooves 13 allow for the use of battery cells 8 with a venting valve and/or venting opening positioned at a respective bottom portion bp of a cell compartment 7. According to further embodiments, the respective cell compartment 7 may lack a venting groove.

As is schematically illustrated in FIG. 8, the coolant tank 1 of the battery module 3 may comprise a number of structures 16, 16′ arranged inside the inner volume V of the coolant tank 1, wherein the number of structures 16, 16′ is arranged to occupy space so as to reduce the size of the inner volume V of the coolant tank 1. The number of structures 16, 16′ may be attached to one or both of the bottom wall segment w2 and the wall segment w1 which forms the recessed formations 4. According to the illustrated embodiments, each of the number of structures 16, 16′ has a substantially triangular cross section in a plane P1 perpendicular to the center axes Ca of the cell compartments 7. Moreover, according to the illustrated embodiments, each of the number of structures 16, 16′ is hollow. However, according to further embodiments, the number of structures 16, 16′ may have another shape and may be solid.

In FIG. 8, only three structures 16, 16′ are schematically indicated. However, the coolant tank 1 of the battery module 3 may comprise a larger number of structures 16, 16′, such as for example one structure 16 concentrically arranged between each group of three adjacent cell compartments 7 and one structure 16′ arranged between each pair of adjacent cell compartments 7 along the side wall segments w3-w6 of the coolant tank 1.

Moreover, according to some embodiments, the number of structures 16, 16′ may form part of a structure assembly configured to divert the flow of coolant through the inner volume V of coolant tank 1 such that an at least substantially uniform flow of coolant is provided around the cell compartments 7 when coolant is pumped into the coolant inlet 11 and through the inner volume V of the coolant tank 1 to the coolant outlet 12. In this manner, the number of battery cells 8 of the battery module 3 can be cooled in an at least substantially uniform manner.

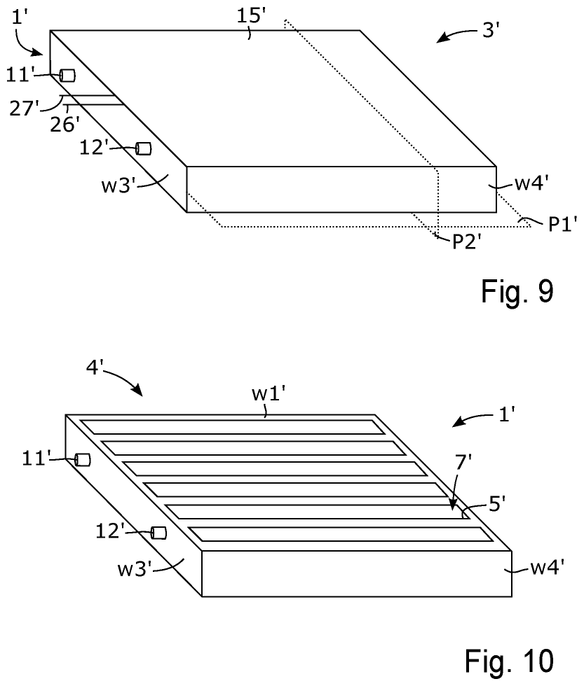

FIG. 9 schematically illustrates a battery module 3′ according to some further embodiments. As indicated in FIG. 2, the battery pack 10 may comprise a number of battery modules 3′ according to the embodiments illustrated in FIG. 9.

The battery module 3′ comprises a connection plate 15′ and a coolant tank 1′. Moreover, as is further explained herein, the battery module 3′ comprises a number of battery cells attached to the connection plate 15′. The connection plate 15′ comprises electrical connection conductors 26′, 27′ being electrically connected to the number of battery cells as is further explained below. The coolant tank 1′ comprises a coolant inlet 11′ and a coolant outlet 12′ as can be seen in FIG. 9.

FIG. 10 schematically illustrates the coolant tank 1′ of the battery module 3′ illustrated in FIG. 9. The coolant tank 1′ is configured to accommodate coolant in an inner volume delimited by a number of wall segments w1′, w3′, w4′ of the coolant tank 1′. In FIG. 10, three wall segments w1′, w3′, w4′ of the coolant tank 1′ are seen and indicated. However, as is further explained below, according to the illustrated embodiments, the coolant tank 1′ comprises six wall segments w1′, w3′, w4′.

As can be seen in FIG. 10, one wall segment w1′ of the number of wall segments w1′, w3′, w4′ forms a number of recessed formations 4′. As is further explained below, each recessed formation 4′ of the number of recessed formations 4′ comprises an inner surface 5′ delimiting a cell compartment 7′ for accommodating a battery cell.

In FIG. 10, the wall segment w1′ is schematically illustrated as forming six recessed formations 4′. However, the wall segment w1′ may form another number of recessed formations 4′.

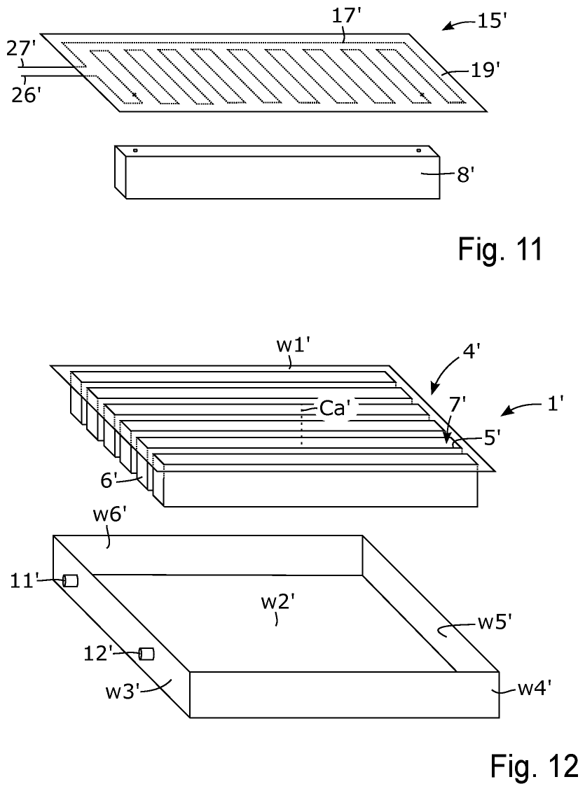

FIG. 11 schematically illustrates a perspective view of the connection plate 15′ of the battery module 3′ illustrated in FIG. 9. Below, simultaneous reference is made to FIG. 1, FIG. 2, and FIG. 9-FIG. 11, if not indicated otherwise.

The connection plate 15′ comprises a plate body 19′ and a number of electrical conductors 17′ arranged on the plate body 19′. According to the illustrated embodiments, the plate body 19′ is provided in a polymeric material and the number of electrical conductors 17′ is provided in metal.

Moreover, FIG. 11 schematically illustrates a battery cell 8′. For reasons of brevity and clarity, only one battery cell 8′ is illustrated in FIG. 11. However, the connection plate 15′ of the battery module 3′ may comprise the same number of battery cells 8′ as the number of recessed formations 4′ formed by the wall segment w1′ of the coolant tank 1′ of the battery module 3′. In other words, the battery module 3′ may comprise a number of battery cells 8′ each being arranged in one cell compartment 7′ of the coolant tank 1′. Each of the number of battery cells 8′ may be a lithium-ion battery cell, a lithium polymer battery cell, or the like.

Each of the number of battery cells 8′ are configured to be attached to the connection plate 15′. Moreover, each battery cell 8′ of the number of battery cells 8′ comprises a pair of electrical poles each being configured to be electrically connected to at least one electrical conductor 17′ of the number of electrical conductors 17′ arranged on the plate body 19′. The electrical poles of the battery cell 8′ have not been provided with reference signs in FIG. 11 for reasons of brevity and clarity. The number of electrical conductors 17′ is electrically connected to the electrical connection conductors 26′, 27′ of the connection plate 15′.

FIG. 12 schematically illustrates a second perspective view of the coolant tank 1′ of the battery module 3′ illustrated in FIG. 9 in which the coolant tank 1′ is illustrated in a partly assembled state in which one wall segment w1′ has been removed from the other wall segments w2′-w6′ of the coolant tank 1′. Below, simultaneous reference is made to FIG. 1, FIG. 2, and FIG. 9-FIG. 12, if not indicated otherwise.

In FIG. 12, all wall segments w1′-w6′ of the coolant tank 1′ are seen and are indicated. The wall segments w1′-w6′ of the coolant tank 1′ comprises a bottom wall segment w2′ and four side wall segments w3′-w6′. The bottom wall segment w2′ and the four side wall segments w3′-w6′ may together form one coherent unit. The bottom wall segment w2′ and the four side wall segments w3′-w6′ may be provided in a polymeric material or in metal. The unit formed by the bottom wall segment w2′ and the four side wall segments w3′-w6′ may comprise a fluid-tight seal member arranged against the inner surfaces of the bottom wall segment w2′ and the four side wall segments w3′-w6′, wherein the bottom wall segment w2′ and the four side wall segments w3′-w6′ are arranged to support the fluid-tight seal member.

As mentioned above, one wall segment w1′ of the number of wall segments w1′-w6′ of the coolant tank 1′ forms a number of recessed formations 4′. Moreover, as mentioned, each recessed formation 4′ of the number of recessed formations 4′ comprises an inner surface 5′ delimiting a cell compartment 7′ for accommodating a battery cell 8′. Furthermore, as is seen in FIG. 12, each recessed formation 4′ of the number of recessed formations 4′ comprises an outer surface 6′. The outer surfaces 6′ of the number of recessed formations 4′ delimits the inner volume of the coolant tank 1′ when the coolant tank 1′ is in an assembled state, as is illustrated in FIG. 10.

According to the illustrated embodiments, the wall segment w1′ forming the number of recessed formations 4′ constitutes a top wall segment of the coolant tank 1′. However, according to further embodiments, the wall segment w1′ forming the number of recessed formations 4′ may constitute a bottom wall segment or a side wall segment of the coolant tank 1′. The feature that the wall segment w1′ forming the number of recessed formations 4′ constitutes a top wall segment of the coolant tank 1′ means that the wall segment w1′ is arranged above the bottom wall segment w2′ as seen relative to the vertical direction vd of the vehicle 2 when the battery module 3′ is arranged in the battery pack 10, the battery pack 10 is mounted to the vehicle 2, and the vehicle 2 is placed in the intended use position onto a flat horizontal surface H.

As is seen in FIG. 12, the number of recessed formations 4′ of the wall segment w1′ forms a number of recesses as seen from a first side of the wall segment w1′ and a number of protrusions as seen from a second side of the wall segment w1′, wherein the second side of the wall segment w1′ is opposite to the first side of the wall segment w1′.

The number of battery cells 8′ of the connection plate 15′ illustrated in FIG. 11 are configured to be inserted into the cell compartments 7′ formed by the number of recessed formations 4′ from the first side of the wall segment w1′ referred to above. In FIG. 12, a center axis Ca′ of one of the cell compartments 7′ is indicated. The center axis Ca′ of a cell compartment 7′ as referred to herein may be a geometrical center axis in which the distances from the center axis to the inner surfaces 5, which delimits the cell compartment 7′, are maximized in all radial directions. The number of battery cells 8′ of the connection plate 15′ illustrated in FIG. 11 are configured to be inserted into the cell compartments 7′ in a direction coinciding with the center axes Ca′ of the cell compartment 7′.

The wall segment w1′ forming the number of recessed formations 4′ may be provided in a polymeric material. According to such embodiments, the wall segment w1′ may be provided by injection moulding. According to some further embodiments, the wall segment w1′ forming the number of recessed formations 4′ may be provided in metal. According to such embodiments, the wall segment w1′ forming the number of recessed formations 4′ may be provided by pressing a metal plate material. Moreover, according to such embodiments, as well as in other embodiments explained herein, each battery cell 8′ of the number of battery cells 8′ may be covered by an electric insulator.

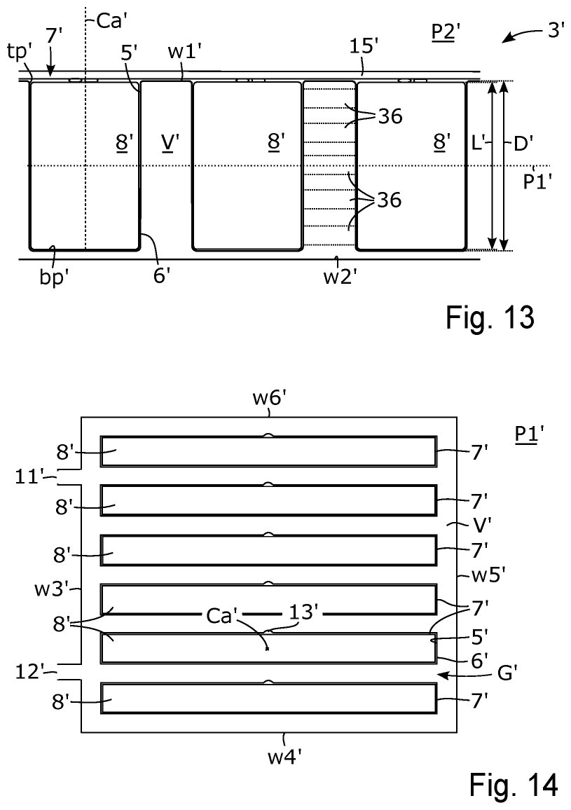

FIG. 13 schematically illustrates a first cross section of a portion of the battery module 3′ illustrated in FIG. 9. In FIG. 13, the cross section is made in a plane P2′ parallel to the center axes Ca′ of the cell compartments 7′. The plane P2′ is also indicated in FIG. 9. Moreover, in FIG. 13, as well as in FIG. 9, a plane P1′ being perpendicular to the center axes Ca′ of the cell compartments 7′ is indicated. Below, simultaneous reference is made to FIG. 1, FIG. 2, and FIG. 9-FIG. 13, if not indicated otherwise.

According to the illustrated embodiments, the plane P1′ being perpendicular to the center axes Ca′ of the cell compartments 7′ is parallel to the bottom wall segment w2′ and to a top surface of the wall segment w1′ which forms the recessed formations 4′. Moreover, according to the illustrated embodiments, the plane P2′ parallel to the center axes Ca′ of the cell compartments 7′ is parallel to two side wall segments w3′, w5′ of the coolant tank 1′.

In FIG. 13, the inner volume V′ of the coolant tank 1′ is indicated. The coolant inlet 11′ and the coolant outlet 12′ indicated in FIG. 9, FIG. 10, and FIG. 12 are fluidly connected to the inner volume V′ of the coolant tank 1′. Moreover, as is indicated in FIG. 1, the vehicle 2 comprises a battery coolant system 23. The battery coolant system 23 is configured to circulate coolant through the inner volume V′ of the coolant tank 1′ by pumping coolant into the coolant inlet 11′ and retrieving coolant from the coolant outlet 12′. The coolant may comprise a mixture of water and glycol. This is because the features of the coolant tank 1′ of the battery module 3′ circumvents the need for using a dielectric coolant while at least in part replicating the advantages of immersion cooling as is further explained herein.

The battery coolant system 23 may comprise one or more radiators configured to radiate heat from coolant retrieved from the coolant outlet 12′ of the coolant tank 1′ to the surroundings. Moreover, the battery coolant system 23 may comprise a heat pump circuit configured to lower the temperature of coolant supplied to the coolant inlet 11′ of the coolant tank 1′ to a temperature below ambient temperature. Furthermore, the battery coolant system 23 may comprise a heater, such as an electrical heater, configured to heat coolant before it is supplied to the coolant inlet 11′ of the coolant tank 1′ for example upon low ambient temperatures.

In FIG. 13, a depth D′ of a cell compartment 7′ is indicated. The depths D′ of the cell compartments 7′ of the coolant tank 1′ may be measured in a direction parallel the center axis Ca′ of each cell compartment 7′. Moreover, in FIG. 13, a length L′ of a battery cell 8′ is indicated. Like above, the length L′ of a battery cell 8′ may be measured in a direction parallel to a center axis Ca′ of each cell compartment 7′.

According to the illustrated embodiments, the depth D′ of each cell compartment 7′ is slightly larger than the length L′ of each battery cell 8′ as measured in a direction parallel to a center axis Ca′ of each cell compartment 7′. In other words, according to the illustrated embodiments, the entire length L′ of each battery cell 8′ is accommodated inside each cell compartment 7′ of the coolant tank 1′. In this manner, an efficient and uniform regulation of the temperature of battery cells 8′ can be provided while not requiring any physical contact between the battery cells 8′ and the coolant accommodated in the inner volume V′ of the coolant tank 1′. According to further embodiments, the depth D′ of each cell compartment 7′ may be at least 20%, at least 35%, or at least 50% of the length L′ of each battery cell 8′ as measured in a direction parallel to a center axis Ca′ of each cell compartment 7′. In this manner, the advantages of immersion cooling can at least in part be replicated while circumventing the need for a physical contact between the battery cells 8′ and the coolant accommodated in the inner volume V′ of the coolant tank 1′.

As is schematically illustrated in FIG. 13, the coolant tank 1′ of the battery module 3′ may comprise a number of elements 36 arranged inside the inner volume V′ of the coolant tank 1′, wherein the number of elements 36 is arranged to occupy space so as to reduce the size of the inner volume V′ of the coolant tank 1′. According to the illustrated embodiments, the number of elements 36 is attached between outer surfaces 6 of adjacent recessed formations 4′. According to further embodiments, the number of elements 36 may be attached inside the inner volume V′ of the coolant tank 1′ in another manner.

According to the embodiments illustrated in FIG. 13, each of the number of elements 36 is formed by a material occupying space while being non-permeable to coolant. As an alternative, or in addition, the coolant tank 1′ according to the embodiments illustrated in FIG. 9-FIG. 13 may comprise a number of structures 16, 16′ as explained with reference to FIG. 8 above. Likewise, the coolant tank 1 of the battery module 3 explained with reference to FIG. 3-FIG. 8 above may comprise a number of elements 36 according to the embodiments illustrated in FIG. 13.

As is seen in FIG. 13, and as is understood from the above described, the number of battery cells 8′ are arranged outside of the inner volume V′ of the coolant tank 1′ when the battery module 3′ is in an assembled state.

FIG. 14 schematically illustrates a second cross section of the battery module 3′ illustrated in FIG. 9. In FIG. 14, the cross section is made in a plane P1′ perpendicular to the center axes Ca′ of the cell compartments 7′. Below, simultaneous reference is made to FIG. 1, FIG. 2, and FIG. 9-FIG. 14, if not indicated otherwise.

As can be seen when comparing FIG. 10, FIG. 11, FIG. 12, and FIG. 14, according to these embodiments, the battery cells 8′ and the cell compartments 7′ have a respective rectangular cross section in the plane P1′ perpendicular to the center axes Ca′ of the cell compartments 7′. Moreover, as is best seen in FIG. 13 and FIG. 14, each of the number of battery cells 8′ has a shape conforming to the shape of the cell compartments 7′ of the coolant tank 1′.

Furthermore, as is best seen in FIG. 14, according to the illustrated embodiments, the inner volume V′ of coolant tank 1′ surrounds the entire circumference of each cell compartment 7′ in a plane P1′ perpendicular to a center axis Ca′ of the cell compartment 7′. In this manner, an efficient and uniform regulation of the temperature of battery cells 8′ can be provided while not requiring any physical contact between the battery cells 8′ and the coolant accommodated in the inner volume V′ of the coolant tank 1′. According to further embodiments, the inner volume V′ of coolant tank 1′ may surround more than 35 %, or more than 60%, of the circumference of each cell compartment 7′ in a plane P1′ perpendicular to a center axis Ca′ of the cell compartment 7′. In this manner, the advantages of immersion cooling can at least in part be replicated while circumventing the need for a physical contact between the battery cells 8′ and the coolant accommodated in the inner volume V′ of the coolant tank 1′.

Moreover, as is indicated in FIG. 14, according to the illustrated embodiments, the coolant tank 1′ is configured such that coolant is directed to flow within gaps G′ between adjacent cell compartments 7′ when the coolant is pumped into the coolant inlet 11′ and through the inner volume V′ of the coolant tank 1′ to the coolant outlet 12′.

Furthermore, as is indicated in FIG. 14, according to the illustrated embodiments, each inner surface 5′ of the respective cell compartment 7′ defines a venting groove 13′. The venting groove 13′ of a cell compartment 7′ extends from a bottom portion bp′ of the cell compartment 7′ to a top portion tp′ of the cell compartment 7′. The bottom and top portions bp, tp of a cell compartment 7′ are indicated in FIG. 13. Since the venting grooves 13′ of the cell compartments 7′ extends from the bottom portions bp of the cell compartments 7′ to the top portions tp of the cell compartments 7′, it can be ensured that any gas formed inside the battery cells 8′ can be vented in an efficient manner via the venting grooves 13′ from the bottom portion bp′ of the cell compartments 7′ to the top portion tp′ of the cell compartments 7′. Moreover, the venting grooves 13′ allow for the use of battery cells 8′ with a venting valve and/or venting opening positioned at a respective bottom portion bp of a cell compartment 7′. According to further embodiments, the respective cell compartment 7′ may lack a venting groove.

Also in these embodiments, the coolant tank 1′ may comprise a structure assembly configured to divert the flow of coolant through the inner volume V′ of the coolant tank 1′ such that an at least substantially uniform flow of coolant is provided around the cell compartments 7′ when coolant is pumped into the coolant inlet 11′ and through the inner volume V′ of the coolant tank 1′ to the coolant outlet 12′. In this manner, the number of battery cells 8′ of the battery module 3′ can be cooled in an at least substantially uniform manner. The structure assembly may for example comprise a number of separating walls preventing flow of coolant through certain passages. Such a structure assembly is not illustrated in FIG. 14 for reasons of brevity and clarity.

As mentioned, the coolant tank 1′ according to the embodiments illustrated in FIG. 9-FIG. 14 may comprise a number of structures 16, 16′ as explained with reference to FIG. 8 above. According to such embodiments, the number of structures 16, 16′ may form part of the structure assembly for diverting the flow of coolant through the inner volume V′ of the coolant tank 1′ such that an at least substantially uniform flow of coolant is provided around the cell compartments 7′.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A coolant tank for a battery module, wherein the coolant tank is configured to accommodate coolant in an inner volume delimited by a number of wall segments of the coolant tank,
wherein one wall segment of the number of wall segments forms two or more cell compartments each formed of a recessed formation in the one wall segment and comprising an outer surface delimiting the inner volume of the coolant tank and an inner surface delimiting a cell compartment for accommodating a battery cell.

2. The coolant tank according to claim 1, wherein the inner volume of coolant tank surrounds: (i) more than 35 %, or (ii) more than 60% of the circumference of each cell compartment in a plane perpendicular to a center axis of the cell compartment.

3. The coolant tank according to claim 1, wherein the coolant tank comprises a coolant inlet and a coolant outlet, and wherein the coolant tank is configured such that coolant is directed to flow within gaps between adjacent cell compartments when the coolant is pumped into the coolant inlet and through the inner volume of the coolant tank to the coolant outlet.

4. The coolant tank according to claim 1, wherein each inner surface of the respective cell compartment defines a venting groove extending from a bottom portion of the cell compartment to a top portion of the cell compartment.

5. The coolant tank according to claim 1, wherein the one wall segment is provided in a polymeric material.

6. The coolant tank according to claim 1, wherein the one wall segment is provided by injection moulding.

7. A battery module comprising:
a coolant configured to accommodate coolant in an inner volume delimited by a number of wall segments of the coolant tank, and wherein one wall segment of the number of wall segments forms two or more cell compartments each formed of a recessed formation in the one wall segment and comprising an outer surface delimiting the inner volume of the coolant tank and an inner surface delimiting a cell compartment for accommodating a battery cell; and
a number of battery cells each arranged in a cell compartment of the coolant tank.

8. The battery module according to claim 7, wherein each of the number of battery cells has a shape conforming to the shape of the cell compartments of the coolant tank.

9. The battery module according to claim 8, wherein the battery cells and the cell compartments are cylindrical.

10. The battery module according to claim 8, wherein the battery cells and the cell compartments each have a respective rectangular cross section in a plane perpendicular to a center axis of the cell compartments.

11. The battery module according to claim 7, wherein a depth of each cell compartment is one of: (i) at least 20%, or (ii) at least 35% of a length of each battery cell as measured in a direction parallel to a center axis of each cell compartment.

12. The battery module according to claim 7 further comprising a connection plate, and wherein each of the number of battery cells, are attached to the connection plate.

13. The battery module according to claim 12, wherein the connection plate comprises a number of electrical conductors, and wherein each of the number of battery cells is electrically connected to at least one electrical conductor of the connection plate.

14. The battery module according to claim 12, wherein the connection plate comprises a plate body and a number of electrical conductors arranged on the plate body, and wherein the plate body is provided in a polymeric material.

15. A battery pack configured to supply electricity to an electric propulsion system of a vehicle, wherein the battery pack comprises one or more battery modules, wherein each battery modules comprises:
a coolant tank configured to accommodate coolant in an inner volume delimited by a number of wall segments of the coolant tank, and wherein one wall segment of the number of wall segments forms two or more cell compartments each formed of a recessed formation in the one wall segment and comprising an outer surface delimiting the inner volume of the coolant tank and an inner surface delimiting a cell compartment for accommodating a battery cell; and
a number of battery cells each arranged in a cell compartment of the coolant tank.

16. A vehicle comprising:
an electric propulsion system configured to provide motive power to the vehicle; and
one or more battery packs, wherein each battery pack comprises one or more battery modules comprising:
a coolant tank configured to accommodate coolant in an inner volume delimited by a number of wall segments of the coolant tank, and wherein one wall segment of the number of wall segments forms two or more cell compartments each formed of a recessed formation in the one wall segment and comprising an outer surface delimiting the inner volume of the coolant tank and an inner surface delimiting a cell compartment for accommodating a battery cell; and
a number of battery cells each arranged in a cell compartment of the coolant tank.

17. The vehicle according to claim 16, wherein the vehicle comprises a battery coolant system configured to circulate coolant through the inner volumes of the coolant tanks of the battery modules of the number of battery packs.

18. The vehicle according to claim 16, wherein the vehicle is a heavy road vehicle.

19. The coolant tank according to claim 1, wherein the cell compartments are cylindrical.

20. The coolant tank according to claim 1, wherein the cell compartments each are rectangular.
